(19) United States
(12) Patent Application Publication
(10) Pub. No.: US 2009/0003205 A1
(43) Pub. Date: Jan. 1, 2009

(54) METHOD AND APPARATUS FOR LOAD DISTRIBUTION CONTROL OF PACKET TRANSMISSION

(75) Inventors: Satoshi Tomie, Kawasaki (JP); Hideki Shiono, Kawasaki (JP); Masaki Hiromori, Kawasaki (JP); Takanori Yasui, Kawasaki (JP); Sadayoshi Handa, Kawasaki (JP); Hirohumi Fujiyama, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/144,058

(22) Filed: Jun. 23, 2008

(30) Foreign Application Priority Data
Jun. 29, 2007 (JP) 2007-171837

(51) Int. Cl. H04L 12/56

(52) U.S. Cl. 370/230; 370/395.32

(57) ABSTRACT

A method for a load distribution control of packet transmission includes calculating bandwidths of individual physical ports at a time when inputted packets are distributed to the plurality of physical ports, using each of a plurality of hash calculation formulas; selecting one of the hash calculation formulas so that the calculated bandwidths of the packets for the respective physical ports may become uniform; and distributing and delivering the packets to the respective physical ports using the updated hash calculation formula.

### CROSS-REFERENCE TO RELATED APPLICATIONS

This application is based upon and claims the benefit of priority from the prior Japanese Patent Application No. 2007-171837 filed on Jun. 29, 2007, the entire contents of which are incorporated herein by reference.

### BACKGROUND

1. Field

The present invention relates to a method and an apparatus for load distribution control of packet transmission.

2. Description of the Related Art

As shown in FIG. 1, the packets of Ethernet (registered trademark) frames are transmitted to a trunk switch 10 in such a way that a plurality of physical ports are bundled and are handled as one logical port. Data from user terminals 30 are aggregated at each switch 20. The packets are aggregated by each link aggregation (LA), which increases a bandwidth and enhances fault immunity.

A packet transmission aspect based on port multiplexing, in which packets are actually being outputted, is shown in FIG. 2. The packets distributed by host packet processing units 2 are subjected to hash calculations in transmission apparatuses 1A and 1B, which correspond to the switches 20 and 10 in FIG. 1, respectively. The hash calculations are performed by hash calculation modules 4 in input/output interface units 3 on the basis of the transmission source addresses, destination addresses, etc. of the packets. Thus, physical ports P1-Pn connected to FiFo ends 7 are determined, and the packets are delivered. Incidentally, the setting of the calculations (a hash function) is basically a static setting.

### RELATED ART EXAMPLE 1

If the hash calculation module 4 in the above system of FIG. 2 distributes the packets PKT equally into odd-numbered addresses and even-numbered addresses as shown in FIG. 3A, the addresses of the packets sometimes deviate as shown in FIG. 3B. In that event, data flows concentrate at one physical port, preventing bandwidth from being satisfactorily used.

In other words, for the purpose of effectively utilizing the bandwidth, it is necessary to grasp the sorts of the data flows beforehand and to set a hash function which distributes the data flows equally.

### RELATED ART EXAMPLE 2

A related art example 2 is intended to cope with such a problem in the related art example 1 (refer to, for example, JP-A-2006-5437). In the related art example 2, as shown in FIG. 4, hash calculations are executed for input packets in a hash calculation module 4 (operation S41). Here, address values (for example, destination addresses), which are the flow identifiers of the packets, are hash-calculated so as to be classified into the groups of respective hash values. In the example of FIG. 4, the address values are classified into 16 groups. In addition, a “bandwidth” and a “bandwidth ratio” are computed for each of the 16 groups of hash values (operation S42).

Meanwhile, as shown in a pre-alteration table TBL0, the corresponding relations between physical ports and the hash values are initially stored in a physical port/hash value correspondence table TBL, which has received the results of the hash calculations (operation S41). In addition, the bandwidth ratios computed by the operation S42 are totaled for every physical port. The table TBL is also controlled so that the hash value groups may be uniformly allotted to the physical ports (operation S43).

Thus, the table TBL is updated to a new post-alteration table TBL1.

In the case of the related art example 2, the problem of non-uniformity of bandwidth still exists among the physical ports, even when the physical port/hash value correspondence table is reconfigured so as to become uniform on the basis of the bandwidth ratios, as stated above. Bandwidth is still non-uniform because the hash calculation module has the single hash calculation formula.

Moreover, the duplication of packets and the reversal of an arrival sequence are not allowed in Ethernet. Nevertheless, in the related art example 2, the sequence reversal sometimes occurs when distribution configurations have been changed-over.

More specifically, it is assumed that, as shown by an example of two physical ports in FIG. 5, a transmission apparatus 1A distributes packets to physical ports P1 and P2 through respective FiFo ends 71 and 72 (hereinbelow, sometimes generally indicated by numeral 7) in the sequence of hash values 3_1, 3_2, 3_3, 3_4, . . . .

It is also assumed that, when the second packet has arrived, table TBL0 is altered to table TBL1, while the FiFo end 71 is changed-over to the FiFo end 72.

Then, before the alteration of table TBL, packets are redirected to the physical port P1, and hence, an output timing is earlier from the physical port P2 than from the physical port P1 (operation S52). This poses the problem that, in a transmission apparatus 1B, the packet 3_3 arrives earlier than the packet 3_2 in the arrival sequence of the packets, resulting in the reversal phenomenon.

### SUMMARY

According to an aspect of an embodiment, a method for load distribution control of packet transmission includes calculating bandwidths of individual physical ports at a time when inputted packets are distributed to the plurality of physical ports, using each of a plurality of hash calculation formulas, selecting one of the hash calculation formulas so that the calculated bandwidths of the packets for the respective physical ports may become uniform, and distributing and delivering the packets to the respective physical ports using the updated hash calculation formula.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 is a diagram showing a general architectural example of an Ethernet network to which an embodiment of the present invention is applied;

FIG. 2 is a block diagram showing a general packet transmission aspect based on port multiplexing;

FIG. 3A is a diagram for explaining a case in which a hash calculation module distributes packets PKT equally into odd-numbered addresses and even-numbered addresses, and in which the addresses do not deviate;

FIG. 3B is a diagram for explaining a case in which the hash calculation module equally distributes the packets PKT into the odd-numbered addresses and the even-numbered addresses, and in which the addresses deviate;

FIG. 4 is a block diagram showing a distribution configuration in a related art example 2;

FIG. 5 is a block diagram showing a problem in the related art example 2;

FIG. 6 is a block diagram showing an example of a transmission apparatus which is an embodiment of a method and an apparatus for the load distribution control of packet transmission according to the invention;

FIG. 7 is a sequence diagram showing a general operating example of the transmission apparatus shown in FIG. 6;

FIG. 8 is a block diagram showing an example of a hash calculation module;

FIG. 9 is a flow chart showing an operating example of the hash calculation module;

FIG. 10 is a block diagram showing an example of a distribution management module;

FIG. 11 is a flow chart showing an operating example of the distribution management module;

FIG. 12 is a block diagram showing an example of a changeover control module; and

FIG. 13 is a flow chart showing an operating example of the changeover control module.

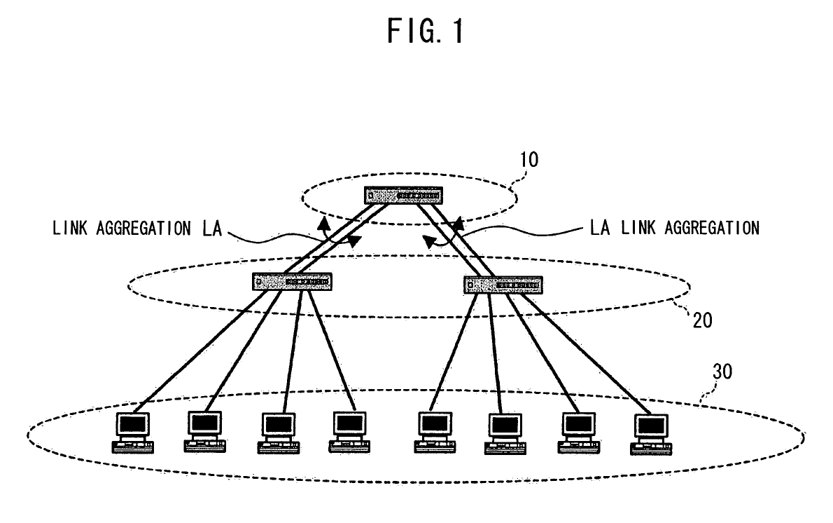

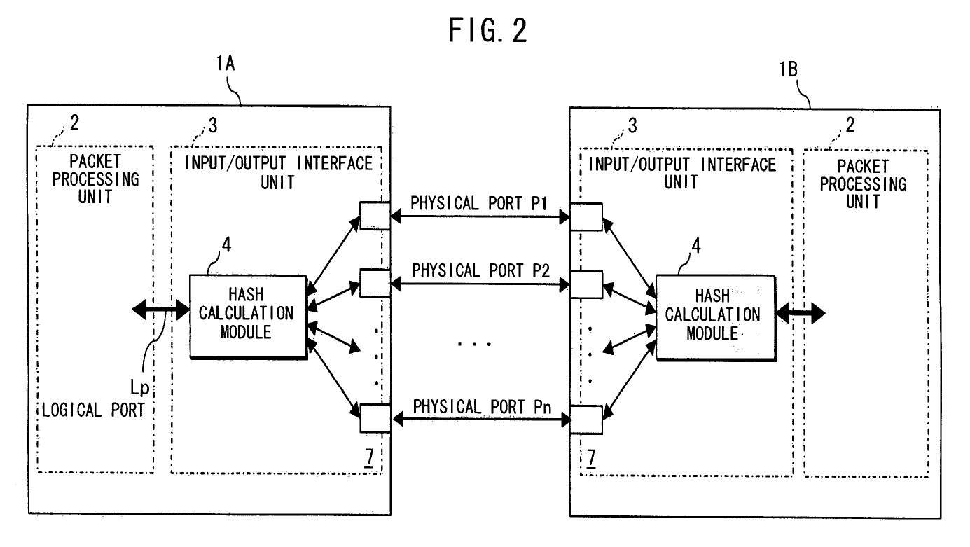

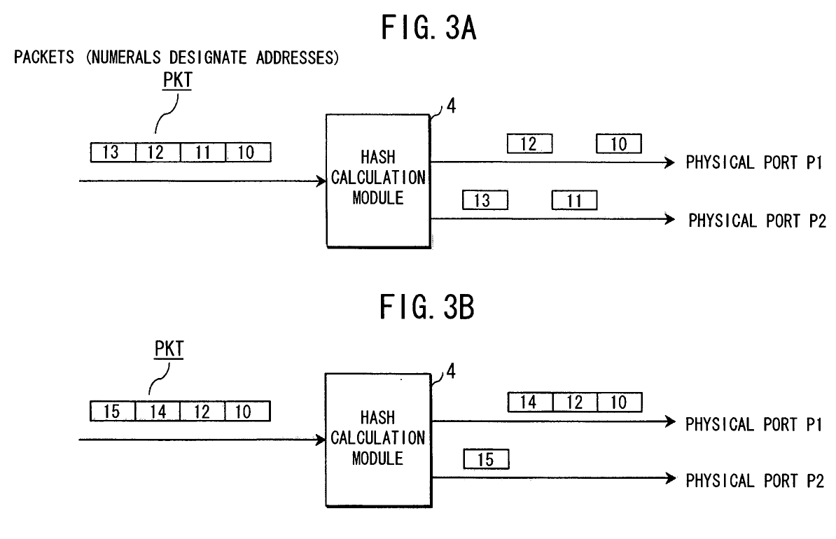

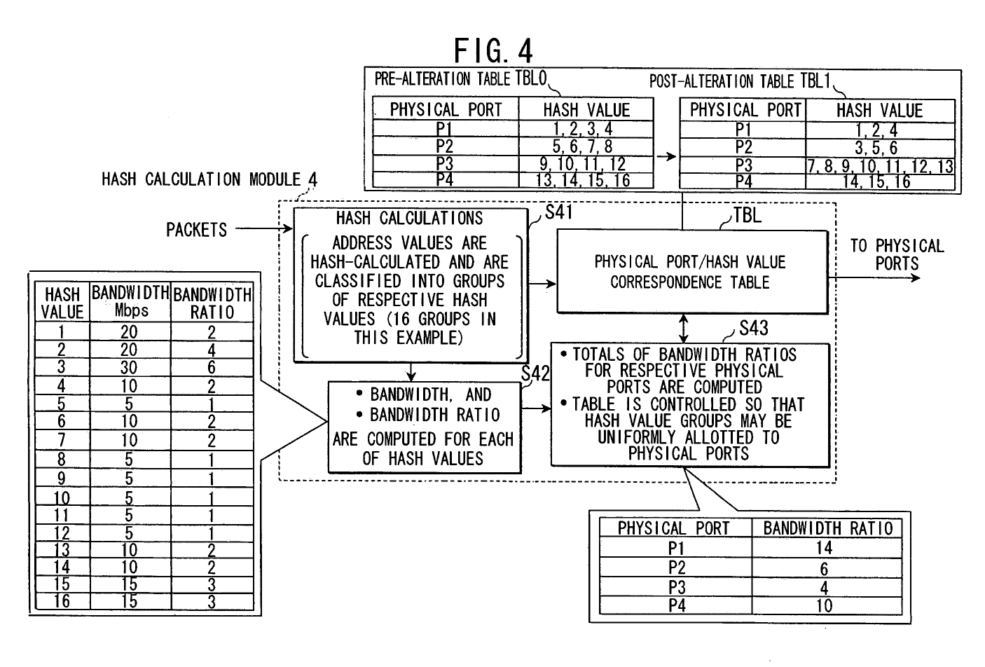

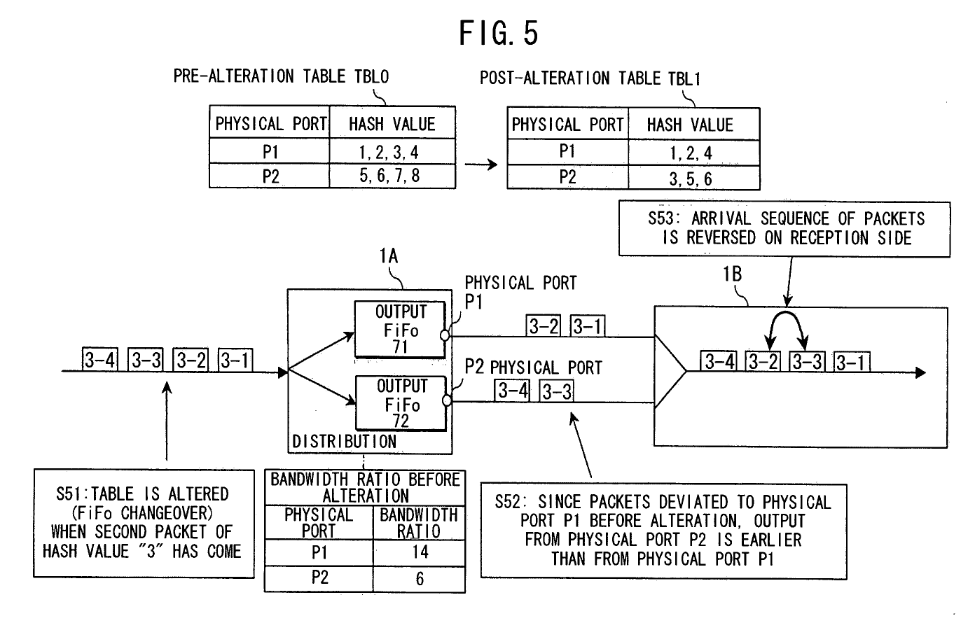

### DETAILED DESCRIPTION OF THE PREFERRED EMBODIMENTS

Reference may now be made in detail to embodiments of the present invention, examples of which are illustrated in the accompanying drawings, wherein like reference numerals refer to like elements throughout.

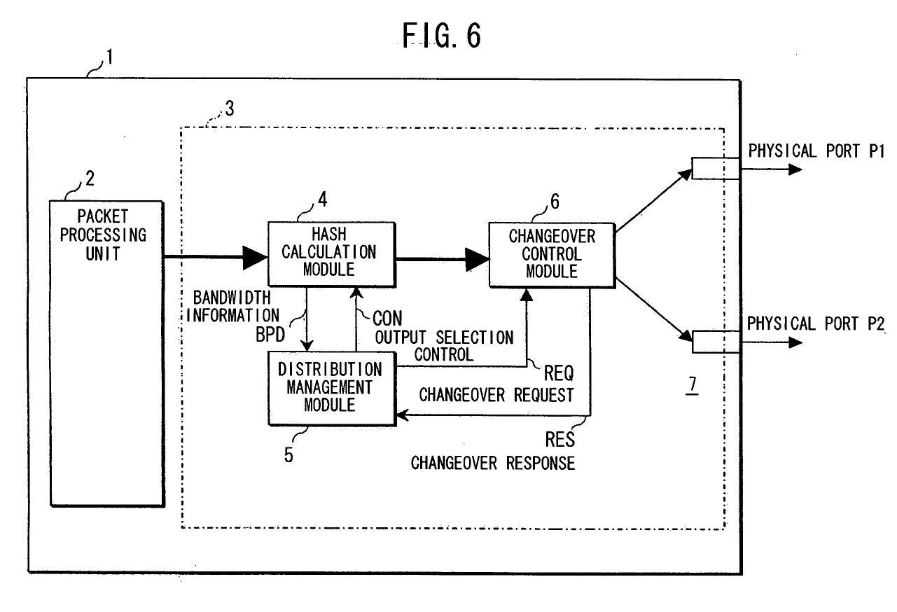

FIG. 6 shows an example an embodiment of a transmission apparatus. The transmission apparatus 1 includes a packet processing unit 2 and an input/output interface unit 3. The input/output interface unit 3 includes the following three blocks:

(1) Hash calculation module 4, (2) distribution management module 5, and (3) changeover control module 6.

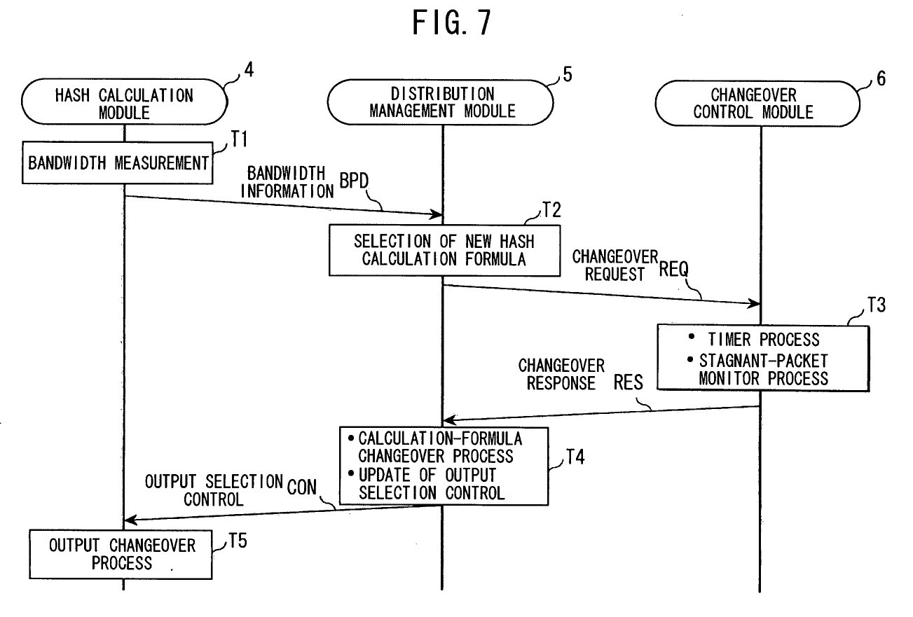

The general operating example of the transmission apparatus 1 will be explained with reference to FIG. 7.

First, packets are distributed in the hash calculation module 4 using a plurality of hash calculation formulas. The data quantity (bandwidth) BPD to be distributed to each physical port is measured in every hash calculation formula (operation T1). The measured bandwidth data BPD is reported to the distribution management module 5.

The optimum calculation formula which makes the service bandwidths of the individual physical ports uniform is selected in the distribution management module 5. The optimum calculation formula is selected on the basis of the physical-port bandwidth quantities BPD of the respective hash calculation formulas (operation T2). Moreover, in a case in which the service bandwidths have become non-uniform with the hash calculation formula which is presently used for the packet distribution, the distribution management module 5 issues a changeover (update) request REQ for the hash calculation formula to the changeover control module 6.

When the changeover control module 6 receives the changeover request REQ, the changeover control module 6 executes a timer process and a stagnant-packet monitor process (operation T3). When the changeover control module 6 has gotten ready for changeover, the changeover control module 6 sends a changeover response RES back to the distribution management module 5.

When the distribution management module 5 has received the changeover response RES, the distribution management module 5 transmits an output selection control signal CON to the hash calculation module 4. This allows the hash calculation module to change the hash calculation formula over to the selected one and execute a distribution process (operation T4).

Upon receiving the output selection control signal CON, the hash calculation module 4 distributes input packets using the selected hash calculation formula and sends the distributed packets to the changeover control module 6 (operation T5). Then, the changeover control module 6 delivers the packets to the physical ports P1 and P2 via FiFo ends 7.

Incidentally, the changeover control module 6 serves to prevent the duplication of the packets and the reversal of an arrival sequence.

The hash calculation module 4 and the distribution management module 5 select the optimum hash calculation formula from among the plurality of hash calculation formulas so as to eliminate the non-uniformity of the bandwidths and make the bandwidths of the respective physical ports uniform.

Moreover, in this example, the two physical ports P1 and P2 are employed for the brevity of the drawing, but it is needless to say that the invention is similarly applicable to a case in which a larger number of physical ports are employed.

Next, examples of the configuration and the operation of the respective blocks in the embodiment shown in FIGS. 6 and 7 will be explained in succession.

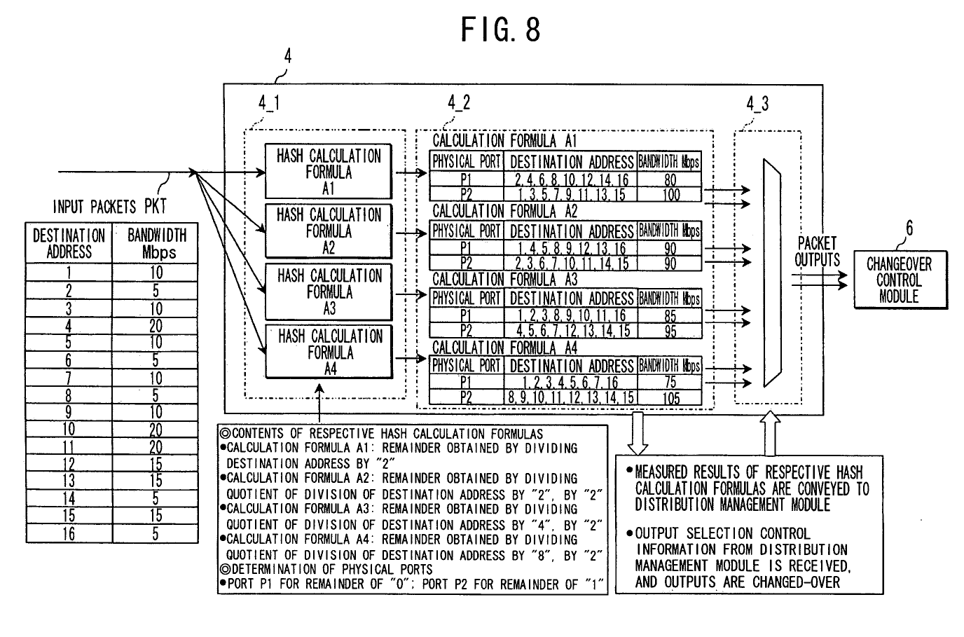

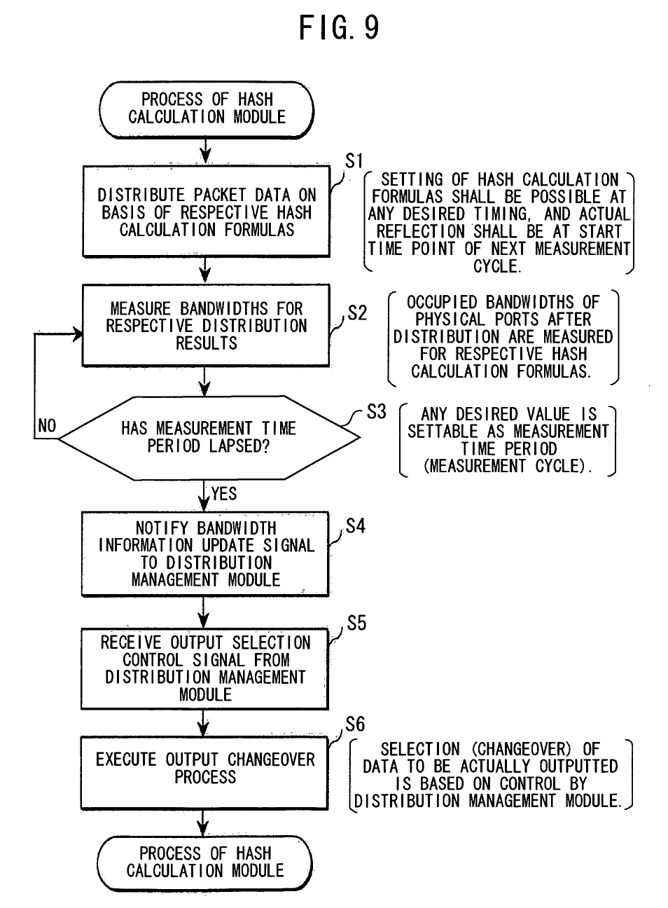

(1) Hash Calculation Module 4: FIGS. 8 and 9

The hash calculation module 4 subjects the address values or label values of packets to calculations by using a plurality of hash calculation formulas. The hash calculation module 4 also determines the output physical ports to which the packets are distributed.

As shown in FIG. 8, the hash calculation module 4 is configured of the following functional blocks:

Hash calculation block 4_1Bandwidth measurement block 4_2Output selection block 4_3

The hash calculation block 4_1 plays the roles of managing the plurality of hash calculation formulas, executing the hash calculations and distributing data. In the example of FIG. 8, the following four hash calculation formulas are managed:

Calculation formula A1: When a remainder obtained by dividing the address of the input packet by “2” is “0”, the packet is distributed to the port P1, and when a remainder is “1” the packet is distributed to the port P2.

Calculation formula A2: When a remainder obtained by dividing the quotient of the division of the address of the input packet by “2”, by “2” is “0”, the packet is distributed to the port P1, and when a remainder is “1”, the packet is distributed to the port P2.

Calculation formula A3: When a remainder obtained by dividing the quotient of the division of the address of the input packet by “4”, by “2” is “0”, the packet is distributed to the port P1, and when a remainder is “1”, the packet is distributed to the port P2.

Calculation formula A4: When a remainder obtained by dividing the quotient of the division of the address of the input packet by “8”, by “2” is “0”, the packet is distributed to the port P1, and when a remainder is “1”, the packet is distributed to the port P2.

Now, when the packets PKT whose destination addresses have bandwidths indicated in FIG. 8 are inputted, the data of the addresses 2, 4, 6, 8, 10, 12, 14 and 16 are distributed to the physical port P1, and the data of the addresses 1, 3, 5, 7, 9, 11, 13 and 15 are distributed to the physical port P2, in the case of the calculation formula A1.

Likewise, in the case of the calculation formula A2, the data of the addresses 1, 4, 5, 8, 9, 12, 13 and 16 are distributed to the physical port P1, and the data of the addresses 2, 3, 6, 7, 10, 11, 14 and 15 are distributed to the physical port P2.

In the case of the calculation formula A3, the data of the addresses 1, 2, 3, 8, 9, 10, 11 and 16 are distributed to the physical port P1, and the data of the addresses 4, 5, 6, 7, 12, 13, 14 and 15 are distributed to the physical port P2.

Moreover, in the case of the calculation formula A4, the data of the addresses 1, 2, 3, 4, 5, 6, 7 and 16 are distributed to the physical port P1, and the data of the addresses 8, 9, 10, 11, 12, 13, 14 and 15 are distributed to the physical port P2 (operation S1 in FIG. 9). Incidentally, the setting of the hash calculation formula may be possible at any desired timing, and the actual reflection thereof may be at the start time point of the next measurement cycle.

The bandwidths of the data distributed by the hash calculation block 4_1 are measured in the bandwidth measurement block 4_2. In addition, the measurements of the service bandwidths of the individual physical ports are performed at fixed time intervals (settable at will) for the respective hash calculation formulas (operations S2 and S3).

In the example of FIG. 8, the service bandwidths of the physical ports P1 and P2 are respectively measured as to the data distributed using the four hash calculation formulas A1 to A4.

In the case of the input packets PKT, which have the bandwidths indicated in FIG. 8, the physical port P1 is allocated 80 Mbps using the calculation formula A1, while the physical port P2 is allocated 100 Mbps. Likewise, using the calculation formula A2, the physical port P1 is allocated 90 Mbps, and the physical port P2 is allocated 90 Mbps. Using the calculation formula A3, the physical port P1 is allocated 85 Mbps, and the physical port P2 is allocated 95 Mbps. Moreover, using the calculation formula A4, the physical port P1 is allocated 75 Mbps, and the physical port P2 is allocated 105 Mbps.

The measured bandwidth information items are conveyed to the distribution management module 5 (operation S4).

Which data among the data distributed by the hash calculation block 4_1 are to be actually outputted is controlled in the output selection block 4_3. The output selection control information (CON) is given by the distribution management module 5 (operation S5), and a selection control is performed in accordance with the control information (operation S6).

To sum up the above operations of the hash calculation module 4, as shown in FIG. 9, the input packets are distributed to the physical ports for the respective hash calculation formulas (operation S1). The service bandwidths of the respective physical ports are thereafter calculated (operation S2). Calculated results are reported to the distribution management module 5 (operation S4). In this case, the measurement and update cycles of the service bandwidths may be settable at will (operation S3), and the update process of the distribution is executed at the set cycles.

Moreover, the output of the hash calculation module 4 is controlled by the distribution management module 5 (operation S5). The selection information of the hash calculation formula to be actually used for the distribution is reported by the distribution management module 5, and when the selection information has been reported, the hash calculation formula to be used for the distribution is changed-over (operation S6).

Incidentally, those hash calculation formulas which are not actually used for the distribution may be dynamically alterable.

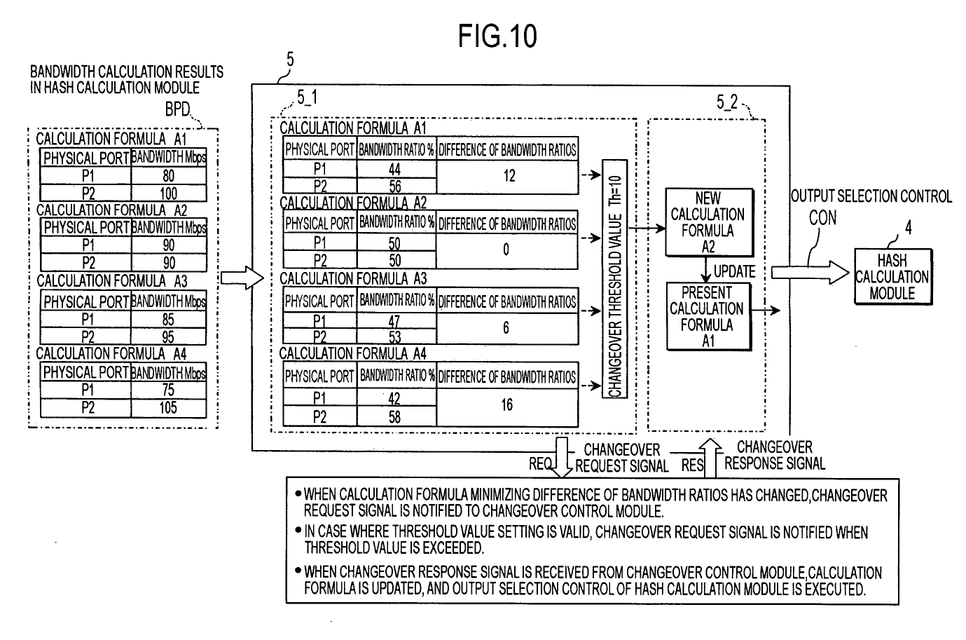

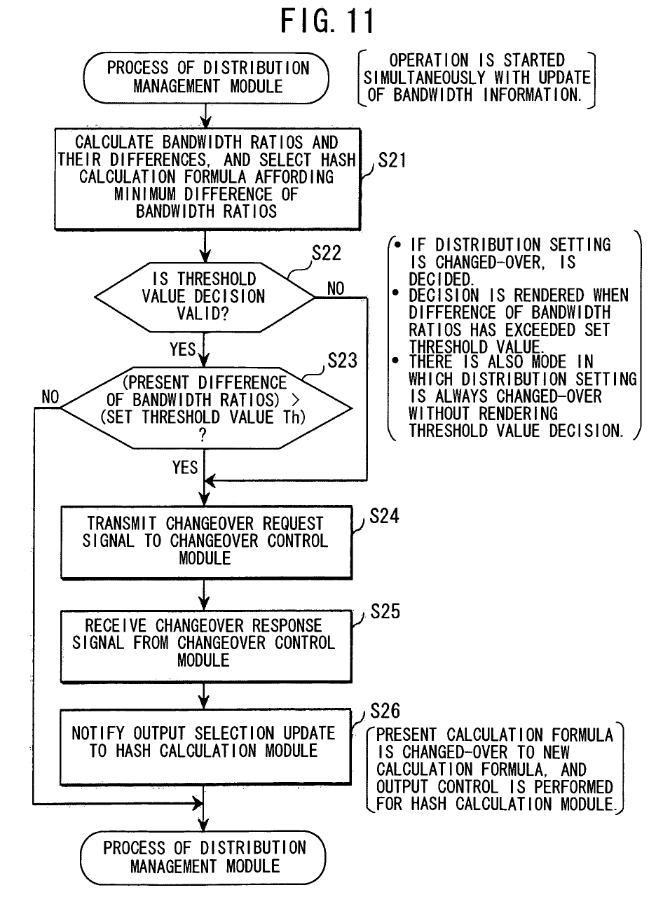

(2) Distribution Management Module 5: FIGS. 10 and 11

The distribution management module 5 selects one of the plurality of hash calculation formulas for which the bandwidths of the individual physical ports become the most uniform, on the basis of the bandwidth information items calculated by the hash calculation module 4.

As shown in FIG. 10, the distribution management module 5 is configured of the following functional blocks:

Hash-calculation-formula determination block 5_1Selection output block 5_2

The hash calculation formula for which the bandwidths of the individual physical ports become the most uniform is selected in the hash-calculation-formula determination block 5_1, on the basis of the bandwidth information items reported by the hash calculation module 4, in the following procedure:

(a) Bandwidth ratios relative to the whole bandwidth of a logical port are calculated for the respective physical ports using each of the individual hash calculation formulas.

(b) The difference between the maximum value and minimum value of the bandwidth ratios (the difference of the bandwidth ratios) is calculated using each of the individual hash calculation formulas.

(c) The minimum value of the differences of the bandwidth ratios of the respective hash calculation formulas is obtained, and the hash calculation formula on that occasion is delivered as a selection result.

In the example shown in FIG. 10, the bandwidth information items of the physical ports P1 and P2 are reported for the four hash calculation formulas A1 to A4. For the data contained in the illustrated table of bandwidth computation results BPD in the hash calculation module 4, the bandwidth ratio of the physical port P1 to the whole bandwidth of the logical port is 44%, and the bandwidth ratio of the physical port P2 to the whole bandwidth of the logical port is 56%, in the case of the calculation formula A1.

Likewise, in the case of the calculation formula A2, the bandwidth ratio of the physical port P1 is 50%, and that of the physical port P2 is 50%.

In the case of the calculation formula A3, the bandwidth ratio of the physical port P1 is 47%, and that of the physical port P2 is 53%.

Moreover, in the case of the calculation formula A4, the bandwidth ratio of the physical port P1 is 42%, and that of the physical port P2 is 58%.

In consequence, the difference of the bandwidth ratios is 12% using the hash calculation formula A1, 0% using the hash calculation formula A2, 6% using the hash calculation formula A3, and 16% using the hash calculation formula A4, as indicated in FIG. 10. Among the calculation formulas, the calculation formula A2 affording the minimum difference of the bandwidth ratios is selected (operation S21 in FIG. 11).

In a case in which the calculation formula thus selected is different from the presently selected calculation formula, the changeover request REQ is issued to the changeover control module 6 (operation S24 in FIG. 11).

Moreover, the hash-calculation-formula determination block 5_1 may well be configured to send out the changeover request REQ when the difference of the bandwidth ratios with the hash calculation formula presently selected has exceeded a certain set threshold value Th (operations S22 and S23 in FIG. 11).

In the example shown in FIG. 10, the formula A1 is presently selected as the hash calculation formula, and the changeover threshold value Th is set at 10%.

The difference of the bandwidth ratios with the present calculation formula A1 is 12%. The difference of the bandwidth ratios exceeds the threshold value Th=10%. Therefore, the changeover request REQ is issued to the changeover management module 6 (operation S24 in FIG. 11).

The changeover response RES from the changeover management module 6 is monitored in the selection output block 5_2. The selection output block 5_2 updates the hash calculation formula presently selected (the calculation formula A1 in the illustrated example) to the calculation formula selected anew (calculation formula A2 in the illustrated example) upon receiving the changeover response RES (operation S25 in FIG. 11). The selection output block 5_2 also transmits the updated selection information CON to the hash calculation module 4 (operation S26 in FIG. 11).

To sum up the above operations of the distribution management module 5, as shown in FIG. 11, the ratios between the bandwidths of the physical ports and the whole bandwidth of the logical port are computed for the respective physical ports. The differences between the maximum values and minimum values of the ratios are obtained as the differences of the bandwidth ratios. In addition, the smallest difference among the differences of the bandwidth ratios for each of the respective hash calculation formulas is selected, and the hash calculation formula on that occasion is delivered as the selection result (operation S21).

The changeover request REQ is sent out to the changeover management module 6 (operation S24) if the selection result is different from the hash calculation formula presently used for the distribution. Alternatively, the changeover request REQ is sent out when the difference of the bandwidth ratios with the hash calculation formula presently used for the distribution has exceeded the set threshold value Th (operations S22 to S24). The threshold value control prevents the changeover requests REQ from being sent out frequently on account of slight deviations.

The distribution management module 5 updates the hash calculation formula presently used for the distribution to the result selected anew upon receiving the changeover response RES from the changeover management module 6 (operation S25). The distribution management module 5 also transmits the selection information to the hash calculation module 4 (operation S26).

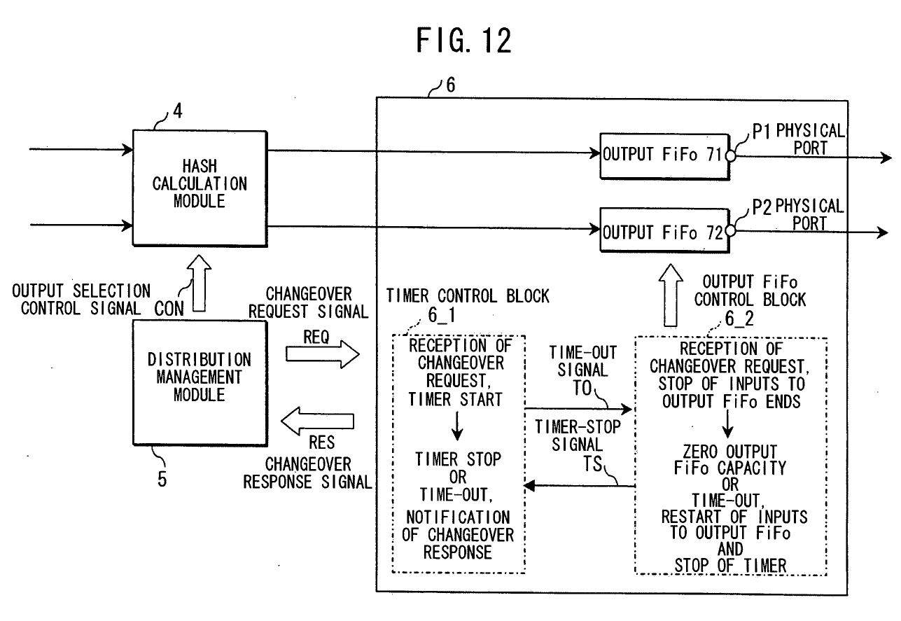

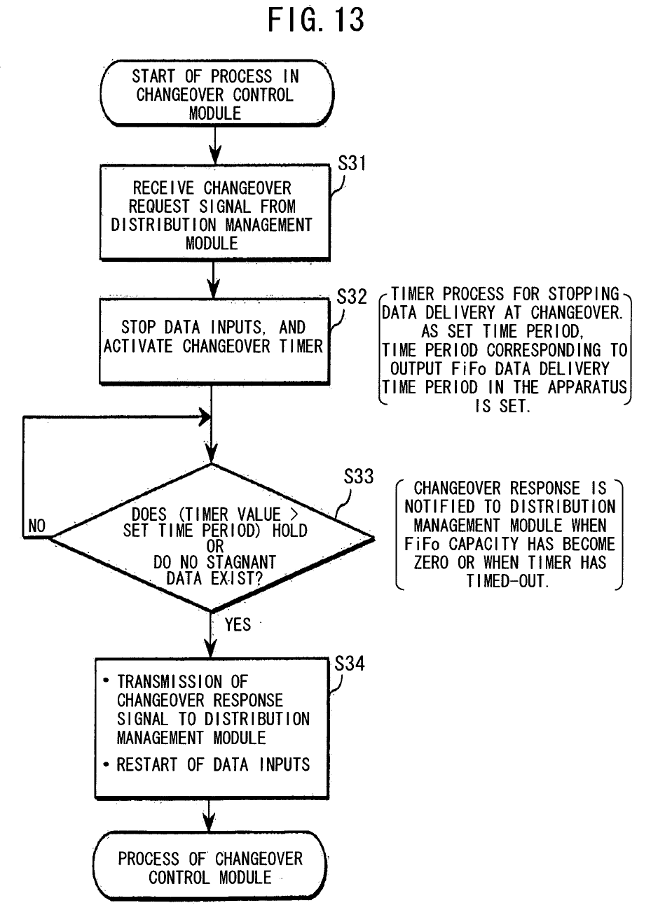

(3) Changeover Control Module 6: FIGS. 12 and 13

When the changeover control module 6 receives the changeover request REQ from the distribution management module 5, the changeover control module 6 activates a timer and tentatively stops transmission of data to the output FiFo ends 7 of the individual physical ports. After a designated time period has elapsed, or when no data have come to stagnate at the output FiFo ends 7, the changeover control module 6 transmits the changeover response RES to the distribution management module 5. Thus, the duplication of packets and the reversal of an arrival sequence are prevented.

As shown in FIG. 12, the changeover control module 6 is configured of the following functional blocks:

Timer control block 6_1, Output FiFo control block 6_2

When the changeover request REQ has been received from the distribution management module 5, the timer is activated in the timer control block 6_1, and the control of stopping data inputs to the output FiFo ends 7 is performed in the output FiFo control block 6_2.

The timer control block 6_1 sends a time-out signal TO to the output FiFo control block 6_2 after the lapse of a set timer time period. At the same time, the timer control block 6_1 transmits the changeover response RES to the distribution management module 5.

The output FiFo control block 6_2 releases the data inputs to the output FiFo ends 71 and 72 upon receiving the time-out signal TO from the timer control block 6_1.

On the other hand, the output FiFo control block 6_2 monitors data quantities stagnating at the output FiFo ends 71 and 72. The output FiFo control block 6_2 sends a timer stop signal TS to the timer control block 6_1 when the stagnant data quantities have become zero.

Upon receiving the timer stop signal TS from the output FiFo control block 6_2, the timer control block 6_1 stops the activated timer and transmits the changeover response RES to the distribution management module 5.

That is, when the timer has timed-out or when no stagnant data have appeared at the output FiFo ends 71 and 72, the changeover response RES is reported to the distribution management module 5.

FIG. 13 shows a process flow at the time of the distribution setting changeover in the changeover control module 6. The changeover operation is executed when the bandwidth information measured in the hash calculation block 4_1 has been updated. Then, the information items of the bandwidth ratios are updated with the respective hash calculation formulas in the distribution management module 5. In the case in which the threshold value decision is valid, the changeover request REQ is reported to the changeover control module 6 (operation S31) when the threshold value is exceeded. Then, the data inputs to the output FiFo ends 71 and 72 are stopped in the changeover control module 6 and the timer is activated (operation S32).

When the set timer time period has elapsed or when no stagnant data have appeared at the output FiFo ends (operation S33), the hash calculation formula selected by the distribution management module 5 is updated (operation S34), and the hash calculation module 4 changes over to the hash calculation formula to be used for the distribution.

Moreover, the changeover control module 6 issues a request to the packet processing unit 2 preceding the hash calculation module 4 to tentatively stop the inputs of data to the hash calculation module 4 during the changeover. This prevents data from being lost during the changeover operation. (During the changeover operation, packets are accumulated in a buffer memory included in the packet processing unit 2.)

Incidentally, it is to be understood that the present invention is not restricted to the foregoing embodiments, but that it is capable of various alterations on the basis of the statements of claims by one skilled in the art.

The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on computer-readable media comprising computer-readable recording media. The program/software implementing the embodiments may also be transmitted over transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. An example of communication media includes a carrier-wave signal.

Further, according to an aspect of the embodiments, any combinations of the described features, functions and/or operations can be provided.

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

What is claimed is:

1. A method for load distribution control of packet transmission, comprising:
calculating bandwidths of individual physical ports at a time when inputted packets are distributed to the plurality of physical ports, using each of a plurality of hash calculation formulas;
selecting one of the hash calculation formulas so that the calculated bandwidths of the packets for the respective physical ports may become uniform; and
distributing and delivering the packets to the respective physical ports using the updated hash calculation formula.

2. The method according to claim 1, wherein said selecting further comprises updating the present hash calculation formula by the hash calculation formula with which the bandwidths calculated are most uniform, when the bandwidths of the packets for the respective physical ports as calculated by the present hash calculation formula have become non-uniform in excess of an allowable range.

3. The method according to claim 1, wherein said selecting further comprises updating the present hash calculation formula after the packets which have been distributed using the present hash calculation formula and which stagnate in buffers connected to the respective physical ports have become zero.

4. The method according to claim 1, wherein said selecting further comprises updating the present hash calculation formula when a stagnation time period of the packets which have been distributed using the present hash calculation formula and which stagnate in buffers connected to the respective physical ports has exceeded a fixed time period.

5. The method according to claim 1, wherein said calculating further comprises calculating the bandwidths of the respective physical ports every fixed time period.

6. An apparatus for load distribution control of packet transmission, comprising:
a first unit to calculate bandwidths of individual physical ports at a time when inputted packets are distributed to the plurality of physical ports, using each of a plurality of hash calculation formulas;
a second unit to select one of the hash calculation formulas so that the calculated bandwidths of the packets for the respective physical ports may become uniform; and
a third unit to distribute and deliver the packets to the respective physical ports using the updated hash calculation formula.

7. The apparatus according to claim 6, wherein said second unit further comprises a unit to update the present hash calculation formula by the hash calculation formula with which the bandwidths calculated by said first unit are most uniform, when the bandwidths of the packets for the respective physical ports as calculated by the present hash calculation formula have become non-uniform in excess of an allowable range.

8. The apparatus according to claim 6, wherein said second unit further comprises a unit to update the present hash calculation formula after the packets which have been distributed using the present hash calculation formula and which stagnate in buffers connected to the respective physical ports have become zero.

9. The apparatus according to claim 6, wherein said second unit further comprises a unit to update the present hash calculation formula when a stagnation time period of the packets which have been distributed using the present hash calculation formula and which stagnate in buffers connected to the respective physical ports has exceeded a fixed time period.

10. The apparatus according to claim 6, wherein said first unit further comprises a unit to calculate the bandwidths of the respective physical ports every fixed time period.
